(19) United States
(12) Patent Application Publication
(10) Pub. No.: US 2020/0277913 A1
(43) Pub. Date: Sep. 3, 2020

(54) METHOD FOR OPERATING AN INTERNAL COMBUSTION ENGINE HAVING AN INJECTION SYSTEM, AND INJECTION SYSTEM FOR CARRYING OUT SUCH A METHOD

(71) Applicant: MTU FRIEDRICHSHAFEN GMBH, Friedrichshafen (DE)

(72) Inventor: Armin DÖLKER, Friedrichshafen (DE)

(21) Appl. No.: 16/647,754

(22) PCT Filed: Sep. 17, 2018
(86) PCT No.: PCT/EP2018/075076

§ 371 Date: Mar. 16, 2020

(30) Foreign Application Priority Data
Sep. 25, 2017 (DE) 10 2017 216 989.3

(51) Int. Cl. F02D 41/22; F02D 41/38; F02M 55/02

(52) U.S. Cl. CPC F02D 41/22; F02D 41/38; F02M 55/025; F02D 2250/31; F02D 2041/224; F02D 2200/0602; F02D 2041/228

(57) ABSTRACT

A method for operating an internal combustion engine having an injection system having a high-pressure accumulator, wherein an instantaneous high pressure in the high-pressure accumulator is monitored in a time-dependent manner by a high-pressure sensor. A first alarm stage is set, if a) a first predetermined high-pressure limit value is exceeded without interruption by the instantaneous high pressure for a predetermined limit time period, and/or b) if the first predetermined high pressure limit value is exceeded for the first time at a predetermined, first limit frequency by the instantaneous high pressure.

The invention relates to a method for operating an internal combustion engine with an injection system and an injection system for an internal combustion engine, which is set up for the implementation of such a method.

From the German patent specification DE 10 2014 213 648 B3 a method for operating an internal combustion engine with an injection system is known, in which a high pressure in a high-pressure accumulator is regulated by means of a suction choke on the low pressure side as the first pressure control element in a first high-pressure control circuit, wherein in normal operation a high-pressure control variable is generated by means of a high-pressure pressure control valve as a second pressure control element, via which fuel is discharged from the high-pressure accumulator into a fuel reservoir. It is provided that in a protective mode the high pressure is controlled via the pressure control valve by means of a second high-pressure control circuit, or that the pressure control valve is permanently opened in the protective mode. In particular, provision is made for a first operating mode of the protective operation to be set when the high pressure reaches or exceeds a first pressure limit value, wherein in the first operating mode the pressure control valve carries out the control of the high pressure. A second operating mode of the protective mode is set if the high pressure exceeds a second pressure limit or if a defect of a high pressure sensor is detected, wherein the pressure control valve is permanently opened in the second mode. In this way, an unacceptable increase in the high pressure can be prevented.

However, if the high pressure nevertheless exceeds a certain threshold, in particular components of injectors of the injection system are so stressed that damage is the result or at least threatens. Methods previously provided for the control and monitoring of high pressure in a high-pressure accumulator do not include measures that are likely to deal with such situations and to efficiently protect injectors of the injection system.

The invention is based on the object to create a method for operating an internal combustion engine with an injection system and an injection system that is set up to perform such a method, wherein the mentioned disadvantages are avoided.

The object is achieved by creating the subject matter of the independent claims. Advantageous embodiments result from the subordinate claims.

The object is achieved in particular by creating a method for operating an internal combustion engine with an injection system—in particular for injecting fuel into at least one combustion chamber of the internal combustion engine—wherein the injection system has a high-pressure accumulator and wherein an instantaneous high pressure in the high-pressure accumulator is monitored against time by means of a high-pressure sensor. In doing so, it is provided that a first alarm stage is set when a first predetermined high pressure limit value of the instantaneous high pressure is continuously exceeded for a predetermined limit period. Alternatively or additionally, the first alarm stage is set when the first predetermined high pressure limit value is exceeded for the first time by the instantaneous high pressure with a predetermined first limit frequency. In this way, it is possible not only to generally monitor an increase in the high pressure and exceeding the high pressure limit value as such, but also to determine for how long the instantaneous high pressure exceeds the high pressure limit value continuously, and/or with what frequency the instantaneous high pressure exceeds the predetermined high pressure limit value. These are relevant parameters with regard to the functionality of injectors of the injection system, as these can be damaged in particular by too long and too frequent loading with an unduly high pressure. The predetermined limit time and/or the predetermined first limit frequency are chosen in particular in such a way that damage to the injectors of the injection system is to be feared if they are reached or exceeded, so that measures are taken to protect them, but also to replace them or at least so that they undergo maintenance.

Particularly preferably, the first alarm stage is set both when the instantaneous high pressure—for the first time—continuously exceeds the first high-pressure limit value for the predetermined limit time and if the instantaneous high pressure has exceeded the first high pressure limit value with the first predetermined limit frequency for the first time. In this way, both the relevant aspects for the protection of the injectors and the safety of the operation of the internal combustion engine can be observed.

The injection system is set up to inject fuel into at least one combustion chamber of the internal combustion engine. The high-pressure accumulator is preferably in the form of a common high-pressure accumulator for a plurality of fuel injectors, wherein the fuel injectors have a flow connection to the high-pressure accumulator and are set up to inject fuel directly into the combustion chambers of the internal combustion engine. Such an injection system is also referred to as a common-rail system. Such a high-pressure accumulator is also referred to as a common bar or rail, in particular a common rail.

When the first alarm stage is set, this means in particular that internally a corresponding variable, a flag or the like that represents the first alarm stage is set within a control unit that is set up for controlling the internal combustion engine. Preferably, the first alarm stage is additionally communicated to the outside, in particular to an operator of the internal combustion engine, in particular by an appropriate output, be it a message in the form of a text output, the lighting of a signal lamp intended for this purpose, an audible signal, a vibration signal, or any other suitable means of signaling the setting of the first alarm stage to an operator of the internal combustion engine. The first alarm stage means in particular that there is a high risk to the injectors of the injection system, and/or that damage to the injectors may at least already have occurred. The first alarm stage corresponds in particular to a red alarm, in which further operation of the internal combustion engine and in particular of the injection system is no longer possible or at most limited.

The check as to whether the instantaneous high pressure has exceeded the first high pressure limit value for the first time with the predetermined first limit frequency is preferably carried out independently of the period of the respective overshoots. In this respect, therefore, it is only detected whether the instantaneous high pressure exceeds the first high pressure limit value at all, in particular regardless of how long this occurs for.

According to a further development of the invention, it is provided that the recording of a time period of the instantaneous high pressure—again—exceeding the first high-pressure limit value is started when the instantaneous high pressure reaches or exceeds the first high pressure limit value from below the first high pressure limit value. “From below” means that the instantaneous high pressure reaches the first high pressure limit value coming from lower high pressure values or overshoots to higher high pressure values. The recorded period is then compared with the predetermined limit period. As soon as the recorded period reaches or exceeds the predetermined limit period, the first alarm stage is preferably set. This is preferably done in real time, so the instantaneous high pressure is monitored permanently and continuously, and the time for which it stays above the first high pressure limit value or remains at the first high pressure limit value is recorded. In particular, starting the recording of this period means that the recording is reinitialized, wherein the recording of the period begins at 0 seconds.

According to a further development of the invention, it is provided that a frequency value indicating a current frequency of the instantaneous high pressure exceeding the first high pressure limit value is incremented when the instantaneous high pressure reaches or exceeds the first high pressure limit value from below a second high pressure limit value, wherein the second high pressure limit value is less than the first high pressure limit value. When recording the frequency of exceeding the first high pressure limit value, hysteresis is thus taken into account, wherein the second high pressure limit value is in particular less than the first high pressure limit value by a hysteresis differential pressure value. If, therefore, the instantaneous high pressure exceeds the first high pressure limit value, for example after a start or commissioning of the internal combustion engine—then necessarily also coming from below the second high pressure limit value—the frequency value is incremented, in particular increased by 1, in particular from 0. If the instantaneous high pressure then falls below the first high pressure limit value, however, wherein however it does not fall below the second high pressure limit value, and subsequently exceeds the first high pressure limit value again—but only from above the second high pressure limit value—the frequency value is not incremented again. The frequency value is only incremented again when the instantaneous high pressure has fallen back below the second high pressure limit value and then again exceeds the first high pressure limit value from below. The instantaneous high pressure must therefore have fallen below the second high pressure limit value from above the first high pressure limit value, so that the frequency value is then incremented. This allows an appropriate separation of independent events that are relevant for possible damage to the injectors, wherein pressure fluctuations around the first high pressure limit value, where the second high pressure limit value is not undershot, are considered to be a coherent event. This can be understood in particular in such a way that in the event of such fluctuations the injector is not subjected to a new pressure shock. Possible damage to the injectors due to permanently excessive pressure is, on the other hand, detected by recording the period of the instantaneous high pressure exceeding the first high pressure limit value and comparing this with the predetermined limit period.

The frequency value is compared with the predetermined first limit frequency. This, too, is preferably done in real time, in particular continuously and permanently, wherein the first alarm stage is set if the frequency value reaches or exceeds the predetermined first limit frequency for the first time.

According to a development of the invention, it is provided that the recorded period is reset, i.e. set to zero, if the instantaneous high pressure falls below the first high-pressure limit value from above the first high pressure limit value—i.e. coming from high pressure values that are greater than the first high pressure limit value. The period is therefore not recorded cumulatively, but the measurement is reinitialized and started each time the instantaneous high pressure exceeds the first high pressure limit value again. Thus, when recording the period, only individual events are recorded separately from each other. The frequency of exceeding the first high pressure limit value, on the other hand, is recorded with the frequency value.

Overall, complementary and at least partially complementary measures are available to detect events harmful to the injectors of the injection system and to identify appropriate measures to protect the injectors.

According to a development of the invention, it is provided that a second alarm stage is set when the first high pressure limit value is exceeded for the first time by the instantaneous high pressure with a predetermined, second limit frequency, wherein the second limit frequency is lower than the first limit frequency. The setting of the second alarm stage means—as already explained for the first alarm stage—in particular that an internal variable, a flag or the like is set. However, the second alarm stage is also preferably communicated to the outside, in particular to an operator of the internal combustion engine, as explained for the first alarm stage. In that regard, reference is made to the remarks relating to the first alarm stage. The second alarm stage preferably indicates that damage to the injectors is possible or even probable during further operation of the internal combustion engine, so that on the part of the operator of the internal combustion engine increased attention should be directed to its operation. If necessary, appropriate measures can already be taken at this time to prevent or reduce further exposure of the injectors, such as appropriate maintenance and/or repair measures. The second alarm stage corresponds in particular to a yellow alarm. The setting of the second alarm stage at the second limit frequency, which is less than the first limit frequency, ensures that the second alarm stage, i.e. the yellow alarm, is set earlier than the first alarm stage, i.e. the red alarm. Thus, an operator of the internal combustion engine is first informed by the second alarm stage that an unduly high load may be applied to the injectors, wherein these may be damaged, wherein the operator is later alerted by the red alarm if in fact damage has already occurred or appears to be almost unavoidable.

The frequency value is preferably compared with the second limit frequency. In particular, the frequency value is preferably compared with the first limit frequency and with the second limit frequency. This, too, is preferably done in real time and in particular permanently and continuously.

According to a development of the invention, it is provided that the injection of fuel from the high-pressure accumulator device into at least one combustion chamber of the internal combustion engine is terminated when the first alarm stage is set. In particular, the injection of fuel is terminated immediately when the first alarm stage is set, especially at the same time as setting the first alarm stage. Thus, with the setting of the first alarm stage, a measure is immediately initiated to protect the injectors—if they are not already damaged—against damage or at least against further major damage. The injection is preferably terminated for all combustion chambers of the internal combustion engine, i.e. for all injectors of the injection system, when the first alarm stage is set. Further operation of the internal combustion engine is then at least initially not possible.

Preferably, however, the injection is continued when the first alarm stage is set, in particular being resumed when the instantaneous high pressure falls below a third high pressure limit value from above the third high pressure limit value, wherein the third high pressure limit value is lower than the first high pressure limit value. In this way, an emergency mode of the internal combustion engine is made possible, so that it can continue to operate, at least if there is currently no risk of further damage to the injectors. In particular, a vehicle, especially a ship, can be provided with a so-called “limp home” function or emergency running function, which makes it possible to reach a safe station, for example a nearest port or the like. The third high-pressure limit is provided with a hysteresis that ensures that the injection is not turned on and off at high frequency and/or continuously, wherein at the same time it is ensured that the instantaneous high pressure must have fallen sufficiently below the first high pressure limit value in order to be able to operate the internal combustion engine without the risk of further damage to the injectors.

The third high-pressure limit value is preferably identical to the second high pressure limit value. In particular, it is therefore preferably less than the first high pressure limit value by the hysteresis differential pressure value.

The continued injection with the first alarm stage set is again terminated once the instantaneous high pressure reaches or exceeds the first high pressure limit value—from below. Thus, once the first alarm stage is set, neither the time of exceeding the first high-pressure limit value nor the frequency of said exceeding is taken into account when monitoring the instantaneous high pressure, but the injection is always immediately ended again when the instantaneous high pressure reaches or exceeds the first high pressure limit value from below the first high pressure limit value. In this way, the injectors of the internal combustion engine are protected and it is ensured that the internal combustion engine can continue to operate, at least in the context of the “limp home” function, at least for a certain period of time, without the injectors completely failing or being destroyed.

According to a development of the invention, it is provided that the first alarm stage and/or the second alarm stage is/are reset if a standstill of the internal combustion engine is detected and—at the same time—an alarm reset request is set. In order to reset at least one of the alarm stages, in particular to reset the first alarm stage, it is necessary to turn the internal combustion engine off, and additionally to set an alarm reset request. In this way, it can be avoided that the first alarm stage can be reset in an inadmissible manner while the internal combustion engine is running and without further measures, which would ultimately result in damage or destruction of the injectors and thus the complete impossibility of further operation of the internal combustion engine. The alarm reset request can be set manually by an operator, for example by pressing a corresponding button, selecting a corresponding menu item in an operating menu of the internal combustion engine, or similar. Preferably, the operator does not manually set the alarm reset request until he is convinced that further operation of the internal combustion engine is possible safely and without damage to the injectors, for example because the injectors have been replaced or because they have been checked sufficiently accurately, or because other maintenance and/or repair measures have been taken to ensure safe operation of the internal combustion engine. However, it is also possible that the alarm reset request is set automatically, especially after a repair and/or replacement of the injectors. For example, the alarm reset request can be set automatically if it is detected that the old injectors have been replaced with new injectors. This can be reported to the control unit, for example, by means of suitable electronic identification means at the injectors, in particular RFID labels or the like, whereupon the control unit can then automatically set the alarm reset request.

According to a development of the invention, it is provided that the predetermined limit period is at least 2 seconds to not more than 3 seconds, preferably 2.5 seconds. It has been found that this corresponds to a period of time during which injectors can be damaged at an unacceptably excessive high pressure.

The first high pressure limit value can preferably be selected at 2400 bar.

The first limit frequency is preferably chosen between at least 45 and not more than 55, preferably it is 50 or 51.

Alternatively or additionally, the second limit frequency is preferably chosen between at least 25 and not more than 35. Preferably, it is 30 or 31.

The frequencies given here for the first limit frequency and the second limit frequency are appropriate frequencies to forewarn the operator of the internal combustion engine on the one hand—in the case of the second limit frequency, and on the other hand—in the case of the first limit frequency—to indicate any damage that may have already occurred or imminent damage to the injectors.

According to a development of the invention, it is provided that the injection or the continued injection is terminated by setting a target injection quantity to zero. The control of the injectors, in particular their energization, is carried out in particular depending on a target injection quantity. If this value is set to zero, no further control is carried out or the injectors are no longer energized, so that the injection is terminated.

Alternatively or additionally, it is possible that the injection or the continued injection is terminated by setting an energization period for at least one injector, preferably for all injectors, to zero. This corresponds to a subsequent suppression of the injection, wherein the target injection quantity may be different from zero, but nevertheless the control, in particular energization of the injectors, is prevented by selecting the intended actuation time provided for this, namely the energization period, as zero. As a result, the injectors are no longer controlled, so the injection is terminated.

The object is also achieved by creating an injection system for an internal combustion engine that has at least one injector for injecting fuel into at least one combustion chamber of the internal combustion engine, as well as a high-pressure accumulator with a flow connection to at least one injector. In addition, the injection system has a high pressure sensor that is set up and arranged for the time-dependent detection of an instantaneous high pressure in the high-pressure accumulator. The injection system has a control unit that is connected to the high pressure sensor and that is set up to carry out a method according to one of the previously described embodiments. In particular, the advantages already explained in connection with the method arise in connection with the injection system.

The control unit is preferably operatively connected to the at least one injector for the control thereof. In particular, it is therefore also able to stop the injection, to resume it, and to stop the continued injection.

It is possible that the control unit is a control unit that is set up and intended separately for the operation of the injection system. Preferably, however, the control unit is a central engine control unit of the internal combustion engine, in particular a so-called Engine Control Unit (ECU).

The invention finally also relates to an internal combustion engine that has an injection system according to any one of the previously described embodiments. In this case, in particular the advantages already explained in connection with the method and the injection system arise in connection with the internal combustion engine.

The internal combustion engine preferably has a plurality of combustion chambers, wherein each combustion chamber is preferably assigned at least one injector for direct injection of fuel into the at least one combustion chamber. These injectors have a flow connection to the high-pressure accumulator, wherein the high-pressure accumulator is in the form of a common high-pressure accumulator for all injectors. The internal combustion engine is preferably in the form of a reciprocating engine. However, the method and the injection system proposed here can also be used for other types of internal combustion engine, such as rotary piston engines, for example.

The invention is explained in more detail below on the basis of the drawing. In the figures:

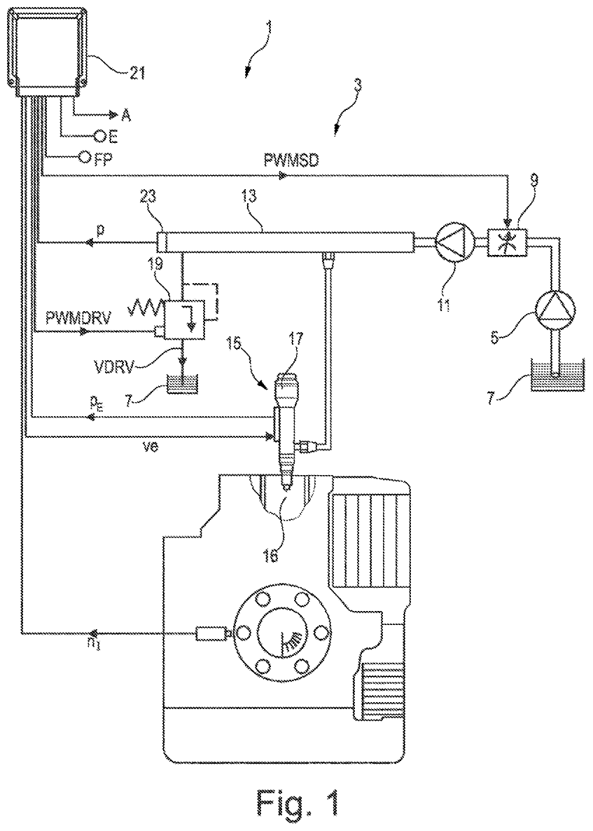

FIG. 1 shows a schematic representation of an exemplary embodiment of an internal combustion engine with an exemplary embodiment of an injection system;

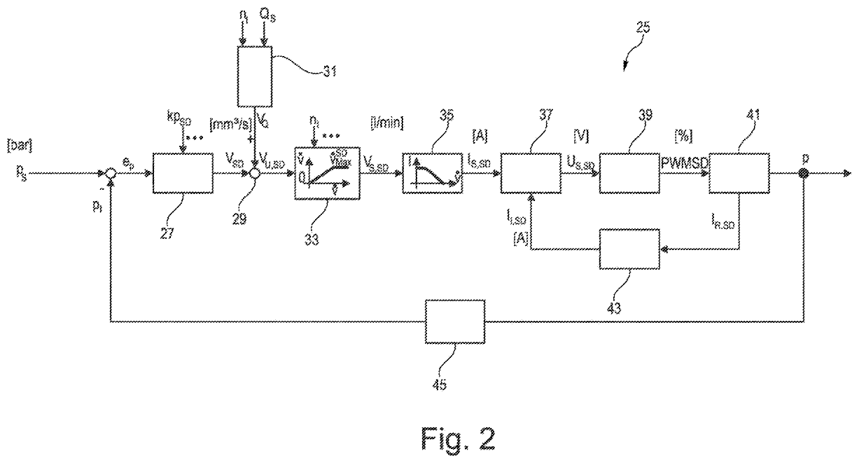

FIG. 2 shows a schematic representation of a high pressure control circuit for controlling a high pressure in a high-pressure accumulator of the injection system;

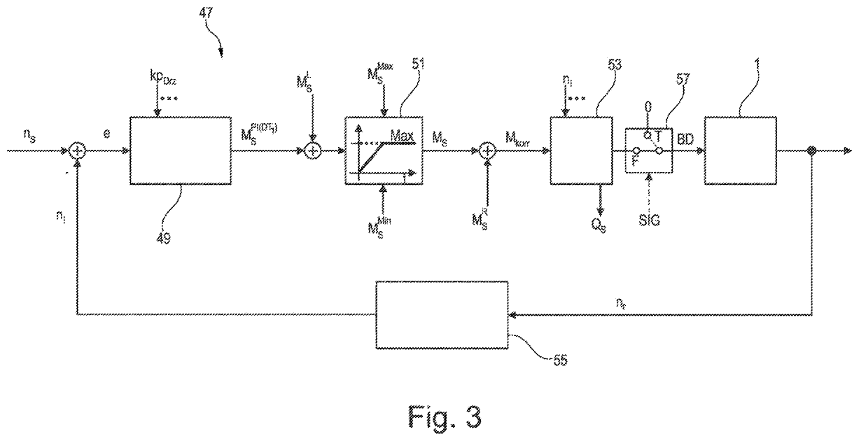

FIG. 3 shows a schematic representation of a revolution rate control circuit with a possibility of optionally performing or preventing an injection;

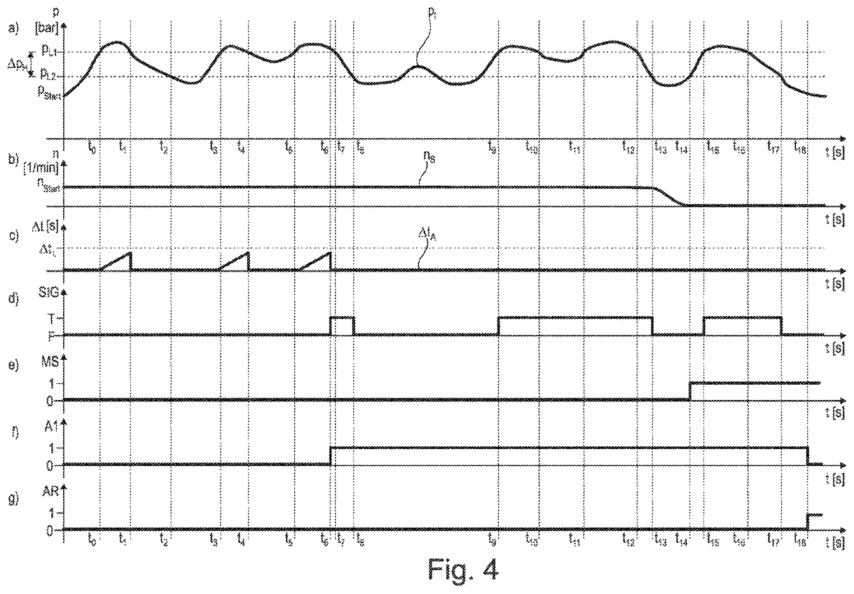

FIG. 4 shows a diagrammatic representation of a first embodiment of a method for operating an injection system;

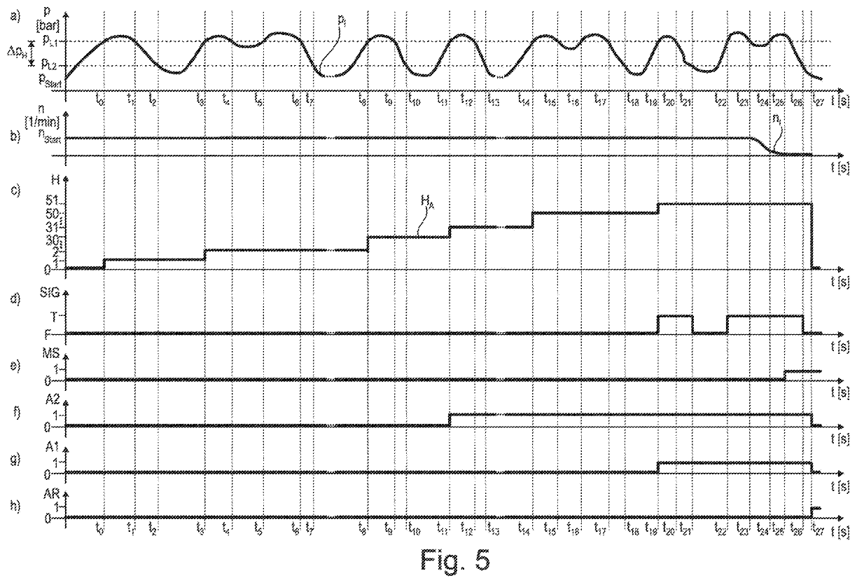

FIG. 5 shows a schematic diagrammatic representation of a second embodiment of such a method, and

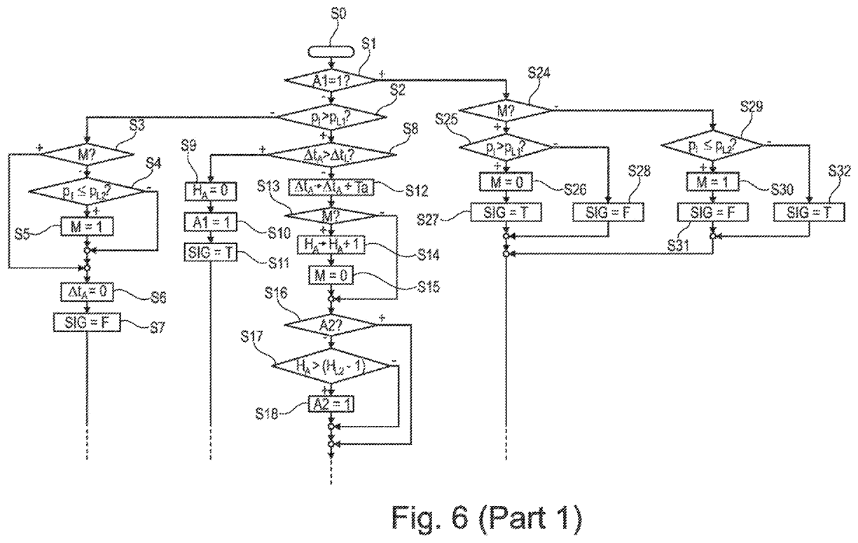

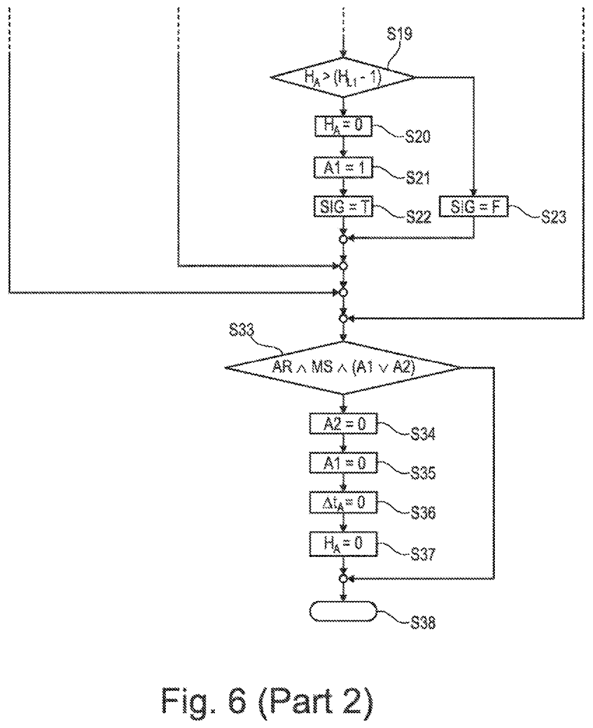

FIG. 6 shows a schematic representation of another embodiment of the method in the form of a flowchart.

FIG. 1 shows a schematic representation of an exemplary embodiment of an internal combustion engine 1 that has an injection system 3. The injection system 3 is preferably in the form of a common rail injection system. It has a low-pressure pump 5 for conveying fuel from a fuel reservoir 7, an adjustable, low-pressure suction choke 9 for influencing a volumetric fuel flow flowing through it, a high-pressure pump 11 for conveying the fuel under increased pressure into a high-pressure accumulator 13, the high-pressure accumulator 13 for storing the fuel, and a plurality of injectors 15 for injecting the fuel into combustion chambers 16 of the internal combustion engine 1. Optionally, it is possible that the injection system 3 is also implemented with individual accumulators, wherein then for example, an individual accumulator 17 is integrated within the injector 15 as an additional buffer volume. A particularly electrically controllable pressure control valve 19 is provided, via which the high-pressure accumulator 13 has a flow connection to the fuel reservoir 7. A volumetric fuel flow, which is discharged from the high-pressure accumulator 13 into the fuel reservoir 7, is defined by the position of the pressure control valve 19. This volumetric fuel flow is designated in FIG. 1 with VDRV and is a high pressure control variable of the injection system 3.

The injection system 3 preferably does not have a mechanical overpressure valve, which is conventionally provided and connects the high-pressure accumulator 13 to the fuel reservoir 7. Its function can be carried out by the pressure control valve 19.

The operating mode of the internal combustion engine 1 is determined by an electronic control unit 21, which is preferably designed as the engine control unit of the internal combustion engine 1, namely as a so-called Engine Control Unit (ECU). The electronic control unit 21 contains the usual components of a microcomputer system, for example a microprocessor, I/O modules, buffers and memory modules (EEPROM, RAM). The operating data relevant for the operation of the internal combustion engine 1 are applied in characteristic fields/characteristic curves in the memory modules. Using these, the electronic control unit 21 calculates output variables from input variables. In FIG. 1, the following input variables are shown as examples: a measured, still unfiltered high pressure p prevailing in the high-pressure accumulator 13 and measured by means of a high pressure sensor 23, a current engine speed n_{I}, a signal FP for specifying the power by an operator of the internal combustion engine 1, and an input variable E. Further sensor signals are preferably summarized in the input variable E, for example a charge air pressure of an exhaust gas turbocharger. In the case of an injection system 3 with individual accumulators 17, a single accumulator pressure p_{E} is preferably an additional input variable of the control unit 21.

By way of example, a signal PWMSD for controlling the suction choke 9 as the first pressure control element, a signal ve for controlling the injectors 15—which in particular specifies an injection start and/or an injection end or even an injection period-, a signal PWMDRV for controlling the pressure control valve 19 as a second pressure control element, and an output variable A are shown in FIG. 1 as output variables of the electronic control unit 21. The position of the pressure control valve 19 and thus the high pressure interference parameter VDRV is defined by the preferably pulse-width modulated signal PWMDRV. The output variable A is representative of further control signals for the control and/or regulation of the internal combustion engine 1, for example for a control signal for activating a second exhaust gas turbocharger during charging of an accumulator.

FIG. 2 shows a schematic representation of a high pressure control circuit 25. Input variables of the high pressure control circuit 25 are a target high pressure p_{S} for the injection system 3, which is preferably specified depending on the operating point by the control unit 21, in particular is read out from a characteristic field, and which is compared with an instantaneous high pressure p_{I} for calculation of a control error eₚ. This control error eₚ is an input variable of a high pressure regulator 27, which is preferably implemented as a PI(DT₁) algorithm. A further input variable of the high pressure regulator 27 is preferably a proportional coefficient kp_{SD}. The output variable of the high-pressure regulator 27 is a volumetric fuel flow V_{SD} for the suction choke 9, to which a target fuel consumption VQ is added in an addition point 29. This target fuel consumption VQ is calculated in a first calculation element 31 as a function of the current speed n_{I} and a target injection quantity QS and represents an interference variable of the high pressure control circuit 25. The sum of the output variable V_{SD} of the high pressure controller 27 and the interference variable VQ results in an unlimited target volumetric fuel flow V_{U, SD}. This is limited in a limiting element 33 as a function of the speed n_{I} to a maximum volumetric flow V_{max,SD} for the suction choke 9. The output of the limiting element 33 is a limited target volumetric fuel flow V_{S, SD} for the suction choke 9, which is input into a pump characteristic curve 35 as the input variable. This converts the limited target volumetric fuel flow V_{S, SD} into a target suction choke current I_{S,SD}.

The target suction choke current I_{S, SD} represents an input variable of a suction choke current controller 37 that has the task of regulating the suction choke flow through the suction choke 9. A further input variable of the suction choke current controller 37 is, among other things, an actual suction choke current I_{I,SD}. The output variable of the suction choke current controller 37 is a suction choke target voltage Us,s_{D}, which is finally converted in a second calculation element 39 in a known way into a switch-on time of a pulse-width modulated signal PWMSD for the suction choke 9. The suction choke 9 is controlled with this pulse-width modulated signal PWMSD, wherein the signal thus acts overall on a control path 41, which in particular comprises the suction choke 9, the high-pressure pump 11 and the high-pressure accumulator 13. The suction choke current is measured, wherein a raw measured value I_{R,SD} results, which is filtered in a current filter 43. The current filter 43 is preferably in the form of a PT₁ filter. The output variable of this current filter 43 is the actual suction choke current I_{I,SD}, which in turn is fed to the suction choke current controller 37.

The control variable of the first high pressure control circuit 25 is the high pressure in the high-pressure accumulator 13. Raw values of this high pressure p are measured by the high pressure sensor 23 and filtered by a high-pressure filter 45, which has the instantaneous high pressure p_{I} as the output variable. The high pressure filter 45 is preferably implemented by a PT₁ algorithm.

The output variable of the high pressure control circuit 25 is therefore, in addition to the unfiltered high pressure p, the filtered high pressure or the actual high pressure p_{I}, which is also referred to in particular as the instantaneous high pressure.

FIG. 3 shows a speed control circuit 47, which is used for speed control. The current engine speed n_{I} is subtracted from a target speed n_{S} specified by the control unit 21, resulting in a speed control error e. This speed control error e is an input variable of a speed controller 49, in this case a PI(DT₁) controller. The speed controller 49 has as a further input variable, among other things a proportional coefficient kp_{Drz} and has a speed controller torque M_{S}^{PI(DTI)} as the output variable. This is added to a load signal torque M_{S}^{L}, wherein the load signal torque M_{S}^{L} is an interference variable. Due to the inclusion of this interference variable, a system signal can be used to improve the dynamics of the speed control circuit 47. The sum of the speed controller torque M_{S}^{PI(DTI)} and the load signal torque M_{S}^{L} is then limited in a torque limiter 51 downwards to a minimum target torque M_{S}^{Min} and upwards to a maximum target torque M_{S}^{Max}. A friction torque M_{S}^{R} is finally added to a target torque M_{S} limited in this way, resulting in a corrected target torque Mₖₒᵣᵣ. This is an input variable of an engine controller 53 in addition to other variables such as the current engine speed n_{I}. An output variable of the engine controller 53 is the target injection quantity Q_{S}. This is injected into the combustion chambers 16 of the internal combustion engine 1. Raw values nᵣ of the engine speed are recorded and converted into the current actual speed n_{I} using a speed filter 55.

The target injection quantity Q_{S} is taken from the high-pressure accumulator 13 and injected into the combustion chambers 16 by means of the injectors 15. If the high pressure in the high-pressure accumulator 13 exceeds a certain threshold for too long, or if the high pressure in the high-pressure accumulator 13 exceeds the predetermined threshold too often, the injectors 15 may be damaged.

In accordance with the method proposed here, it is therefore provided that the high pressure in the high-pressure accumulator 13 is monitored against time by means of the high pressure sensor 23, wherein a first alarm stage is set when a first predetermined high pressure limit value is continuously exceeded by the instantaneous high pressure for a predetermined limit time, and/or if the first predetermined high pressure limit value is exceeded by the instantaneous high pressure for the first time with a predetermined first limit frequency. In this way, an operator of the internal combustion engine 1 can be warned if damage to the injectors 15 is threatened or has already occurred, and preferably further operation of the internal combustion engine 1 can be at least temporarily stopped to prevent further damage or even complete destruction of the injectors 15.

When the first alarm stage is set, the injection of fuel from the high-pressure accumulator 13 into the combustion chambers 16 is preferably terminated. However, the injection is preferably continued with the first alarm stage set if the instantaneous high pressure falls below a third high pressure limit value from above the third high pressure limit value, wherein the instantaneous high pressure is below the third high pressure limit value. The continued injection—during the set first alarm stage—is again terminated as soon as the instantaneous high pressure reaches or exceeds the first high pressure limit value again—from below. In this way, on the one hand the injectors 15 can be protected, and on the other hand the internal combustion engine 1 can continue to operate at least to a limited extent, for example in order to be able to reach a safe station, in particular a seaport or the like. This means that an emergency running function or “limp home” function is provided.

The injection or continued injection is preferably terminated by setting the injection quantity Q_{S} to zero.

However, another method to end the injection or the continued injection is alternatively or even additionally possible, wherein this possibility is shown in FIG. 3: According to this possibility, an energization period BD for the injectors 15 is set to zero. For this purpose, a switching element 57 is provided, preferably in the speed control circuit 47, which can change its switching state in a binary manner depending on a logical signal SIG. The logical signal SIG can assume the values “true” (T) or “false” (F). The logical signal SIG indicates whether a quantity limit for the injection of fuel into the combustion chambers 16 via the injectors 15 is active. The logical signal SIG is set to “true” when the first alarm stage is set and the injection is to be stopped, and if the continued injection is to be stopped. Otherwise—and especially if the injection is to be continued with the first alarm stage set—the value of the logical signal SIG is set to “false”.

If the logical signal SIG has the value “false”, the switching element 57 is in the functional state designated in FIG. 3 with F. In this case, the energization period BD of the motor controller 53 is taken as the output variable, wherein it is predetermined by the motor controller 53, in particular calculated, particularly preferably read from a characteristic field. If, on the other hand, the logical signal SIG has the value “true” and, in this respect, the quantity limit for fuel injection is active, the switching element 57 takes the switching position designated in FIG. 3 with T, so that the energization period BD is set identical to the value zero. In this switching state of the switching element 57, therefore, no energization of the injectors 15 takes place, so that the injection is not carried out.

It is possible that the switching element 57 is in the form of a software switch, i.e. of a purely virtual switch. Alternatively, however, it is also possible that the switching element 57 is in the form of a physical switch, for example of a relay. The logical signal SIG can of course also adopt the numeric values 0 and 1, or other appropriate corresponding values, in a completely analogous way to the values “true” and “false”.

FIG. 4 shows a diagrammatic representation of a first embodiment of the method for operating the injection system 3. A total of seven time diagrams are shown, in which different variables are specified as a function of time t. The first, upper time diagram at a) shows the instantaneous high pressure p_{I} as a solid curve plotted against time t. This rises initially, starting from a starting value p_{Start}. At a first time to, the instantaneous high pressure p_{I} reaches the first predetermined high pressure limit value p_{L1} and subsequently exceeds it. In the third diagram from the top at c) a current time period Δt_{A} is plotted against the time t as a solid curve, which indicates the time for which the instantaneous high pressure p_{I} continuously exceeds the first predetermined high pressure limit value p_{L1}. At the first time t₀, this current time period Δt_{A} is counted—starting from the value zero. At a second time t₁, the instantaneous high pressure p_{I} reaches the first high pressure limit value p_{L1} again from above and subsequently falls below it. Therefore, the current time period Δt_{A} is reset to zero. It has not yet reached or exceeded a predetermined limit period Δt_{L} between the first time t₀ and the second time t₁.

At a third time t₂, the instantaneous high pressure p_{I} falls below a second predetermined high pressure limit value p_{L2}, which is less than the first high pressure limit value p_{L1} by a hysteresis pressure difference value Δp_{H}. The instantaneous high pressure p_{I} drops further after the third time t₂ and then rises again. At a fourth time t₃, the instantaneous high pressure p_{I} again reaches the first high pressure limit value p_{L1} and subsequently exceeds it. As a result, the current time period Δt_{A} is counted again—again starting from zero. At a fifth time t₄, the instantaneous high pressure p_{I} again reaches the first high pressure limit value p_{L1} from above, so that the current time period Δt_{A}, which has not yet reached the limit time Δt_{L}, is reset to the value zero. The actual high-pressure p_{I} falls even further without falling below the second high pressure limit value p_{L2}. A subsequent increase in the instantaneous high pressure p_{I} causes the first high-pressure limit p_{L1} to be exceeded again from below at a sixth time t₅. This in turn leads to the current time period Δt_{A} being counted up again, in particular from zero again. At a seventh time t₆, the current time period Δt_{A} exceeds the predetermined limit time Δt_{L}, which results in the quantity limit for injection being activated and the logical signal SIG changing its value, wherein here it is set to the value “true” denoted by T, which is shown in the fourth diagram from the top at d). As explained in connection with FIG. 3, this means that no more fuel is injected into the combustion chambers 16. The current time period Δt_{A} is set back to zero at the seventh time t₆, thus being reset.

From the sixth diagram from the top at f) it becomes clear that the first alarm stage AI is set at the same time as reaching the limit time period Δt_{L} and the value change of the logical signal SIG from the value F to the value T, which is shown here by a jump of a signal indicating the first alarm stage AI from the value 0 to the value 1.

At an eighth time t₇, the instantaneous high pressure p_{I} again falls below the first high pressure limit value p_{L1} from above, wherein at a ninth time t₈ it finally falls below the second high pressure limit value p_{L2} from above. This causes the logical signal SIG to change its value again and to reset to “false”, i.e. to the value F. The injection is therefore enabled again.

Up to a tenth time t₉, the instantaneous high pressure remains below the first high pressure limit value p_{L1}. At the tenth time t₉, it again exceeds the first high-pressure limit value p_{L1} from below, which then immediately—due to the set first alarm stage—causes the logical signal SIG to be set to the value T again, whereby the injection of fuel into the combustion chambers 16 is stopped again.

Up to a 14th time t₁₃, the instantaneous high pressure remains above the second high pressure limit value p_{L2} so that all variables and/or signals remain unchanged. At the 14^{th} time t₁₃, the instantaneous high pressure p_{I} falls below the second high pressure limit value p_{L2} again from above, which resets the logical signal SIG to the value F. The injection is thus enabled again. At the same time, at the 14th time t₁₃, the internal combustion engine 1 is switched off, so that as a result in the second diagram from the top the current engine speed n_{I} drops from a speed value n_{Start} to zero.

At a 15th time t₁₄, it is detected that the combustion engine 1 is stopped, wherein now a logical variable MS, which indicates that the internal combustion engine is stopped, assumes the value 1. This is shown in the fifth diagram from the top at e).

At a 16th time t₁₅, the instantaneous high pressure p_{I} again exceeds the first high pressure limit value pL1. This causes the logical signal SIG to be set back to the value T. Thus, the injection is deactivated again, i.e. no more fuel is injected into the combustion chambers 16. At a 17th time t₁₆, the instantaneous high pressure p_{I} again falls below the first high pressure limit value p_{L1}. At the 18th time t₁₇ it finally reaches the second high pressure limit value p_{L2} and subsequently falls below it. The logical signal SIG is thus reset to the value F at the 18th time t₁₇, which means that the injection is enabled again.

At the 19th time t₁₈, an alarm reset request AR is set, which is indicated in the seventh diagram at g) by the fact that a corresponding variable takes the value 1. Since the internal combustion engine 1 is stopped at this 19th time t₁₈, the associated first alarm stage AI is reset, i.e. the corresponding variable is set to the value zero.

The injection of fuel into the combustion chambers 16 is stopped if the instantaneous high pressure exceeds the first high pressure limit value p_{L1} continuously during the predetermined limit period Δt_{L}.

Furthermore, FIG. 4 shows that the recording of the time period Δt_{A} is always started, in particular re-initialized and started at zero, when the instantaneous high pressure p_{I} reaches or exceeds the first high pressure limit value p_{L1} from below. The recorded period Δt_{A} is also compared with the predetermined limit period Δt_{L}. Furthermore, it becomes clear that the recorded period Δt_{A} is set to zero if the instantaneous high pressure p_{I} falls below the first high pressure limit value p_{L1} from above p_{L1}. It is also clear that the first alarm stage A1 is cancelled when the internal combustion engine 1 standstill is detected and the alarm reset request AR is set at the same time.

The predetermined limit period Δt_{L} is preferably selected from at least 2 s to no more than 3 s,

particularly preferably at 2.5 s.

FIG. 5 shows a schematic, diagrammatic representation of a second embodiment of the method, which, however, is preferably carried out in combination with the first embodiment explained in connection with FIG. 4.

FIG. 5 shows that the instantaneous high pressure p_{I}, which in turn is plotted in a first, upper diagram at a) against time t, is monitored with a view to a frequency of exceeding the first high pressure limit value p_{L1}. In the second diagram from the top at b) the current engine speed n_{I} is plotted. In a third time diagram from the top at c) a frequency value H_{A} is plotted, which indicates a current frequency of the instantaneous high pressure p_{I} exceeding the first high pressure limit value p_{L1}. In the fourth time diagram from the top at d), the logical signal SIG is again shown. In the fifth time diagram from the top at e), the logical variable M_{S} is again shown. In a sixth time diagram from the top at f), a second alarm stage A2 is shown as a corresponding variable with the logical values 0 and 1. In the seventh time diagram from the top at g), the first alarm stage AI is shown as the corresponding logical variable with the values 0 and 1. In the eighth diagram from the top at h) the alarm reset request AR is shown again.

The first time diagram at a) shows that the instantaneous high pressure p_{I} first increases from the starting value p_{Start} and at a first time t₀ reaches and then exceeds the first high pressure limit value p_{L1}. The third time diagram at c) shows that the frequency value H_{A} is incremented from 0 to 1 due to this limit violation. At a second time t₁, the instantaneous high pressure again reaches the first high pressure limit value p_{L1} from above, wherein at a third time t₂ it also falls below a third high pressure limit value, which is identical here with the second high pressure limit value p_{L2} according to FIG. 4. In principle, the third high pressure limit value can also be selected differently from the second high pressure limit value p_{L2}. However, it corresponds to a preferred design for the third high-pressure limit value to be chosen equal to the second high pressure limit value p_{L2}, wherein the third high pressure limit value is then also just smaller than the first high pressure limit value p_{L1} by the hysteresis differential pressure value Δp_{H}. As a result, the instantaneous high pressure p_{I} rises again and at a fourth time t₃ again exceeds the first high pressure limit value p_{L1}. This results in the frequency value H_{A} being incremented again, from the value 1 to the value 2. At a fifth time t₄, the instantaneous high pressure p_{I} falls below the first high pressure limit value p_{L1} again from above. At a sixth time t₅, the instantaneous high pressure p_{I} again exceeds the first high pressure limit value p_{L1} from below, without first reaching or falling below the second high pressure limit value p_{L2} from above. Therefore at the sixth time t₅ the frequency value H_{A} is not incremented.

At a seventh time t₆, the first high-pressure limit value p_{L1} is again exceeded by the instantaneous high pressure p_{I}, wherein the second high pressure limit value p_{L2} is then also exceeded at an eighth time t₇. As a result, the instantaneous high pressure p_{I} exceeds or falls below the first high-pressure limit value p_{L1} even more times, as well as the second high pressure limit value p_{L2}. This is indicated in FIG. 5 by a dotted representation of all time diagrams.

At a ninth time t₈, the actual high pressure p_{I}, i.e. the instantaneous high pressure, exceeds the first high pressure limit value p_{L1} again. It is assumed here for the explanation that the frequency value H_{A} is incremented to the value 30. At a tenth time t₉, the instantaneous high pressure p_{I} again falls below the first high pressure limit value p_{L1} and also reaches or falls below the second high-pressure limit value p_{L2} at an eleventh time t₁₀. At a twelfth time t₁₁, the instantaneous high pressure p_{I} again exceeds the first high pressure limit value p_{L1}, which results in the frequency value H_{A} being incremented to the value 31.

This now results in the second alarm stage A2 being set, wherein the corresponding logical variable is set from the value 0 to the value 1, which is shown in the sixth time diagram at f). The second alarm stage A2 is therefore set when the first high pressure limit value p_{L1} is exceeded for the first time by the actual high pressure, i.e. the instantaneous high pressure p_{I}, with a predetermined second limit frequency, which is less than a first limit frequency, which is defined for setting the first alarm stage AI, which will be explained below. The second limit frequency is selected here to be 31. It can also preferably be selected to be 30. Preferably, the second limit frequency is chosen between 25 and 35. The frequency value H_{A} is also compared with the second limit frequency—and as explained below—with the first limit frequency. The second alarm level A2 corresponds in particular to a yellow alarm, by which an operator of the internal combustion engine 1 is warned of possible damage to the injectors 15.

At a 13th time t₁₂, the first high-pressure limit value p_{L1} is exceeded and at a 14th time t₁₃, the second high-pressure limit is reached p_{L2} and subsequently also undershot. The instantaneous high pressure p_{I} subsequently exceeds and falls below the first high pressure limit value p_{L1} and also the second high pressure limit value p_{L2} further times, which in turn is indicated by a dotted representation of all time diagrams.

At a 15th time t₁₄, the instantaneous high pressure p_{I} exceeds the first high-pressure limit value p_{L1} again. It is assumed for the explanation that the frequency value H_{A} is incremented to 50. At a 16th time t₁₅, the instantaneous high pressure p_{I} again falls below the first high pressure limit value p_{L1}. At a 17th time t₁₆, the actual high-pressure p_{I} again exceeds the first high pressure limit value p_{L1} without having previously reached or exceeded the second high-speed limit p_{L2}. Therefore no increment of the frequency value H_{A} is carried out at this time. At an 18th time t₁₇, the first high pressure limit value p_{L1} is again exceeded. At a 19th time t₁₈, the second high pressure limit value p_{L2} is reached and then undershot.

At a 20th time t₁₉, after a further increase the instantaneous high pressure p_{I} again exceeds the first high-pressure limit p_{L1}, wherein the frequency value H_{A} is incremented to the value 51. This now results in the first limit frequency being reached, wherein the first alarm stage AI—see diagram g)—is set. The first limit frequency is therefore preferably selected to be 51 here. It can also be selected to be 50. In general, the first limit frequency is preferably selected to be between 45 and 55.

Setting the first alarm stage AI in turn causes the energization of the injectors 15 to be stopped, whereby no more fuel is injected into the combustion chambers 16. This is done by changing the logical signal value SIG from F to T—see diagram d).

At a 21st time t₂₀, the instantaneous high pressure p_{I} again falls below the first high pressure limit value p_{L1}. At a 22^{nd} time t₂₁, the instantaneous high pressure p_{I} reaches the second high pressure limit value p_{L2}, which results in the injection being enabled again by the logical signal SIG changing its value from T to F. At a 23rd time t₂₂, the instantaneous high pressure p_{I} again exceeds the first high pressure limit value p_{L1}, which means that the fuel injection into the combustion chambers 16 is stopped again by the logical signal SIG again assuming the value T. At a 24th time t₂₃, the internal combustion engine 1 is switched off, which leads to a drop of the current engine speed n₁. At the same time, the actual high-pressure p_{I} falls below the first high-pressure limit value p_{L1}. As a result, the instantaneous high pressure p_{I} continues to drop and then rises again without having previously reached or exceeded the second high pressure limit value p_{L2}. At a 25th time t₂₄, the instantaneous high pressure p_{I} again exceeds the first high pressure limit value p_{L1}. At a 26th time t₂₅, the current engine speed n_{I} reaches the value 0, that is, the internal combustion engine 1 is now at a standstill. As a result, the logical variable M_{S} also changes value from 0 to 1. At a 27th time t₂₆, the instantaneous high pressure p_{I} again falls below the second high pressure limit value p_{L2} from above, which means that the logical signal SIG is changed to the value F. At a 28th time t₂₇, the alarm reset request AR is set. Since the internal combustion engine 1 is stationary, this causes all alarms, i.e. the first alarm stage AI and the second alarm stage A2, to be reset. At the same time, the frequency value H_{A} is also reset to zero after triggering the alarm reset request AR with the internal combustion engine 1 at a standstill.

It can therefore be seen that the frequency value H_{A}, which indicates the current frequency of the instantaneous high pressure, i.e. the actual high pressure p_{I}, exceeding the first high pressure limit value p_{L1}, is incremented when the instantaneous high pressure reaches or exceeds the first high pressure limit value p_{L1} from below the second high pressure limit value p_{L2}. The frequency value H_{A} is compared with the predetermined limit frequency, in particular with both the first limit frequency and the second limit frequency.

The second alarm stage A2 is also cancelled if both the standstill of the internal combustion engine 1 is detected and the alarm reset request AR is set.

The control unit 21 is specially set up to carry out the method described here.

This is now explained in more detail in connection with FIG. 6.

FIG. 6 shows a schematic representation of another embodiment of the method in the form of a flowchart. This embodiment may also be provided cumulatively with the embodiments according to FIGS. 4 and 5, wherein preferably all steps and features of the method explained in connection with FIGS. 4 to 6 are carried out in combination with each other.

Before the method starts in a start step S0, the value of a variable M, which represents a marker and is also referred to below as a marker variable, and which can take the values 0 and 1, is initialized to 1. The current time period Δt_{A} is updated to the value zero, and the frequency value H_{A} is also initialized to zero.

In a first step SI a query is carried out as to whether the first alarm stage AI is set. If this is not the case, the method is continued in a second step S2, in which a query is carried out as to whether the instantaneous high pressure p_{I} is greater than the first high pressure limit value p_{L1}. If this is not the case, the method is continued in a third step S3, in which a check is carried out as to whether the marker variable M has the value 1, i.e. is set, which is the case according to the aforementioned initialization at a first start of the method. If the variable M is set, the method is continued in a sixth step S6. If, on the other hand, the variable M is not set, i.e. it has a value of 0, the method continues at a fourth step S4. In this a check is carried out of whether the instantaneous high pressure p_{I} is less than or equal to the second high pressure limit value p_{L2}. If this is not the case, the method continues with the sixth step S6. However, if this is the case, in a fifth step S5 the marker variable M is set to the value 1, then the method proceeds with the sixth step S6. In the sixth step S6, the current time period Δt_{A} is set to zero. After the sixth step S6, a seventh step S7 is executed, wherein the logical signal SIG is set to the value F. Then the method proceeds with a 33rd step S33.

If the result of the query in the second step S2 is positive, i.e. the instantaneous high pressure p_{I} is actually greater than the first high pressure limit value p_{L1}, the method will be continued in an eighth step S8. In this eighth step S8, a check is carried out as to whether the current time period Δt_{A} is greater than the predetermined limit period Δt_{L}. If this is the case, the method continues with a ninth step S9, a tenth step S10, an eleventh step SII and then the 33rd step S33. In the ninth step S9, the frequency value H_{A} is set to the value zero. In the tenth step S10, the first alarm stage AI is set. In the eleventh step S11, the logical signal SIG is set to the value T.

If, on the other hand, the result of the query in the eighth step S8 is negative, i.e. if the current time period Δt_{A} is less than or equal to the limit period Δt_{L}, the method is continued in a twelfth step S12. In this step, the time variable Δt_{A} is incremented by a process-inherent sampling time Ta.

In a 13th step S13, the marker variable M is queried again. If this is not set, the method continues with a 16th step S16. If it is set however, i.e., it has the value 1, the frequency value H_{A} is incremented in a 14th step S14. The marker variable M is then set to zero in a 15th step S15.

In the 16th step S16, a query is carried out as to whether the second alarm stage A2 is set. If this variable is set, i.e. it has a value of 1, the method is continued with a 19th step S19. If it is not set, i.e. if it has a value of zero, the method is continued with a 17th step S17. In this 17^{th} step S17, a check is carried out as to whether the frequency value H_{A} is greater than the second limit frequency H_{L2} reduced by 1. If this is not the case, the method is continued with the 19th step S19, otherwise with the 18th step S18, in which the second alarm stage A2 is set. In the 19th step S19, a query is carried out as to whether the frequency value H_{A} is greater than the first limit frequency H_{L1} reduced by 1. If this is the case, the method is continued with a 20th step S20, a 21st step S21, a 22nd step S22 and then the 33rd step S33. If, on the other hand, this is not the case, the method is continued with a 23rd step S23 and then the 33rd step S33. In the 20th step S20, the frequency value H_{A} is set to zero. In the 21st step S21 the first alarm stage AI is set. In the 22nd step S22, the logical signal SIG is set to the value T. In the 23rd step S23, on the other hand, the logical signal SIG is set to the value F.

If the result of the query in the first step S1 is positive, i.e. the first alarm stage AI is set, the method is continued with a 24th step S24. In this 24th step S24, the variable M is queried. If this is set, the method is continued with a 25th step S25, otherwise with a 29th step S29. In the 25th step S25, a query is carried out as to whether the instantaneous high pressure p_{I} is greater than the first high pressure limit value p_{L1}. If this is the case, the method is continued with a 26th step S26, a 27th step S27 and then with the 33rd step S33. If, on the other hand, the high pressure p_{I} is less than or equal to the first high pressure limit value p_{L1}, the method is continued with a 28th step S28 and then the 33rd step S33.

In the 26th step S26, the marker variable M is set to zero. In the 27th step S27, the logical signal SIG is set to the value T. In the 28th step S28, the logical signal SIG is set to the value F.

In the 29th step S29, a check is carried out as to whether the instantaneous high pressure p_{I} is less than or equal to the second high pressure limit value p_{L2}. If this is the case, the method is continued with a 30th step S30, a 31st step S31 and then the 33rd step S33. If this is not the case, the method is continued with a 32nd step S32 and then with the 33rd step S33. In the 30th step S30, the marker variable M is set to the value 1. In the 31st step S31, the logical signal SIG is set to the value F. In the 32nd step S32, the logical signal SIG is set to the value T.

In the 33rd step S33 a check is carried out as to whether the following conditions are met at the same time—i.e. cumulatively: The alarm reset request AR is set, the internal combustion engine 1 is at a standstill, i.e. the logical variable M_{S} is set, and either the first alarm stage AI or the second alarm stage A2 is set. If these conditions are met cumulatively, the method is continued with a 34th step S34, a 35th step S35, a 36th step S36 and a 37th step S37. In the 34th step S34, the second alarm stage is reset. In the 35th step S35, the first alarm stage is reset. In the 36th step S36, the current time period Δt_{A} is set to zero. In the 37th step S37, the frequency value H_{A} is set to zero. The program then ends in an end step S38. If one of the cumulative conditions of the 33rd step S33 is not met, the program sequence ends in the end step S38 without passing through steps S34 to S37.

The method is preferably carried out continuously and iteratively, so that it starts again with the starting step S0 as soon as it has finished at the end step S38. The initialization of the marker variable M, the current period Δt_{A} and the frequency value H_{A} with the values mentioned in the figure description of FIG. 6 is carried out only at a very first start of the program sequence, but by no means for each pass, but rather the values from the previous pass are carried over for these variables for each new pass following a previous pass, otherwise the logic of the method would not work. The duration of a pass through the method is preferably the duration of the sampling step Ta in each case, wherein this ensures in particular that the current period Δt_{A} is always correctly updated in the twelfth step S12.

In particular, the following advantages arise in connection with the invention: injectors 15 can be damaged if their components are overloaded due to excessive fuel pressures in the high-pressure accumulator 13. Such an excessive loading occurs when the instantaneous high pressure is either above a first limit value for too long a period of time, or if this limit is exceeded too frequently. The method proposed here makes it possible to protect the injectors 15 against further damage by disabling the injection of fuel into combustion chambers 16 in both cases. The injection of fuel is only enabled again when the high pressure falls below the first limit by a hysteresis differential pressure value. This allows the internal combustion engine 1 to continue operating in a kind of emergency mode despite possible prior damage until the operator has the possibility to carry out a maintenance measure, in particular to replace the injectors 15. The fact that replacement of the injectors 15 or maintenance is required is indicated to the operator by the triggering of the first alarm stage AI, i.e. of the red alarm, preferably with a corresponding error message. In order to warn the operator in advance, the second alarm stage A2, i.e. a yellow alarm, is triggered at an early stage, namely when a certain number of limit values that is still permissible have been detected.

1-10. (canceled)

11. A method for operating an internal combustion engine with an injection system that has a high-pressure accumulator, comprising the steps of: monitoring an instantaneous high pressure in the high-pressure accumulator against time by a high pressure sensor; and, setting a first alarm stage when
a) a first predetermined high pressure limit value of the instantaneous high pressure is continuously exceeded for a predetermined limit period, and/or when
b) the first predetermined high pressure limit value is exceeded for a first time by the instantaneous high pressure with a predetermined, first limit frequency.

12. The method according to claim 11, further comprising starting a recording of a period of time of the instantaneous high pressure exceeding the first high pressure limit value when the instantaneous high pressure reaches or exceeds the first high pressure limit value from below the first high pressure limit value, and comparing the recorded period with the predetermined limit period.

13. The method according to claim 11, including incrementing a frequency value, which indicates a current frequency of exceeding the first high pressure limit value by the instantaneous high pressure, when the instantaneous high pressure exceeds the first high pressure limit value from below a second high pressure limit value, wherein the second high pressure limit value is lower than the first high pressure limit value, and wherein the frequency value is compared with the predetermined first limit frequency.

14. The method according to claim 12, further including setting the recorded period to zero when the instantaneous high pressure falls below the first high pressure limit value from above the first high pressure limit value.

15. The method according to claim 11, further including setting a second alarm stage when the first high pressure limit value is exceeded for the first time by the instantaneous high pressure with a predetermined, second limit frequency, wherein the second limit frequency is less than the first limit frequency.

16. The method according to claim 11, further including terminating an injection of fuel from the high-pressure accumulator into at least one combustion chamber of the internal combustion engine when the first alarm stage is set.

17. The method according to claim 16, including:
a) continuing the injection of fuel with the first alarm stage set if the instantaneous high pressure falls below a third high pressure limit value from above the third high pressure limit value, wherein the third high pressure limit value is less than the first high pressure limit value, and
b) stopping the continued injection with the first alarm stage set as soon as the instantaneous high pressure reaches or exceeds the first high pressure limit value.

18. The method according to claim 13, further including terminating an injection of fuel from the high-pressure accumulator into at least one combustion chamber of the internal combustion engine when the first alarm stage is set, including:
a) continuing the injection of fuel with the first alarm stage set if the instantaneous high pressure falls below a third high pressure limit value from above the third high pressure limit value, wherein the third high pressure limit value is less than the first high pressure limit value, and
b) stopping the continued injection with the first alarm stage set as soon as the instantaneous high pressure reaches or exceeds the first high pressure limit value.

19. The method according to claim 18, wherein the third high pressure limit value is equal to the second high pressure limit value.

20. The method according to claim 15, including canceling the first alarm stage and/or the second alarm stage when a standstill of the internal combustion engine is detected and simultaneously setting an alarm reset request.

21. The method according to claim 15, including selecting the predetermined limit period to be at least 2 s to not more than 3 s, preferably 2.5 s, and/or selecting the first, predetermined limit frequency to be at least 45 to not more than 55, preferably 50 or 51, and/or selecting the second predetermined limit frequency to be at least 25 to not more than 35, preferably 30 or 31.

22. The method according to claim 21, including selecting the predetermined time limit to be 2.5 s.

23. The method according to claim 21, including selecting the first, predetermined limit frequency to be 50 or 51.

24. The method according to claim 21, including selecting the second predetermined limit frequency to be 30 or 31.

25. The method according to claim 17, wherein the injection or the continued injection is terminated by:
a) setting a target injection quantity to zero, and/or by
b) setting an energization period for at least one injector to zero.

26. An injection system for an internal combustion engine, comprising:
at least one injector;
a high-pressure accumulator with a flow connection to the at least one injector;
a high pressure sensor set up and arranged to record an instantaneous high pressure in the high-pressure accumulator against time; and
a control unit connected to the high pressure sensor and configured to carry out the method according to claim 11.
